(19) United States
(12) Patent Application Publication
(10) Pub. No.: US 2013/0121712 A1
(43) Pub. Date: May 16, 2013

(54) IMAGE HEATING APPARATUS, IMAGE FORMING APPARATUS, AND IMAGE HEATING SYSTEM

(71) Applicant: CANON KABUSHIKI KAISHA, Tokyo (JP)

(72) Inventor: Keigo Kaji, Abiko-shi (JP)

(73) Assignee: CANON KABUSHIKI KAISHA, Tokyo (JP)

(21) Appl. No.: 13/657,186

(22) Filed: Oct. 22, 2012

(30) Foreign Application Priority Data
Nov. 16, 2011 (JP) 2011-250497

(51) Int. Cl. G03G 15/00; G03G 15/20

(52) U.S. Cl. 399/44; 399/69; 399/45

(57) ABSTRACT

When a heater is turned off before passing of a rear end of a sheet through a fixing device, a poor image such as a poor fixing occurs and it is difficult to reduce power consumption. A stop timing of the heater is controlled according to a temperature state of the fixing device, an installation environment of the apparatus, a kind of the sheet, or the like.

### BACKGROUND OF THE INVENTION

1. Field of the Invention

The present invention relates to an image heating apparatus, an image forming apparatus, and an image heating system.

As an image heating apparatus, there is a fixing device that fixes a non-fixed image formed on a recording material or a glossiness application apparatus that improves the degree of glossiness of an image by heating an image fixed on a recording material. As an image forming apparatus, there are a copying machine that obtains a hardcopy by forming an image on a recording material, for example, by using an electrophotographic system, a fax machine, a printer, and a multifunctional product of them.

2. Description of the Related Art

Recently, a fixing device with a small thermal capacity has been proposed and practically used, as an image heating apparatus that fixes a non-fixed image formed on a recording material, for saving energy, in an image forming apparatus using an electrophotographic system. As a detailed method of reducing thermal capacity of a fixing device, there is a belt-fixing system that uses a belt-shaped endless belt (hereinafter, referred to as a fixing belt) as a fixing member, and the following configurations have been proposed.

Japanese Patent Laid-Open No. 2006-293225 (U.S. Patent Application Publication No. 2006/0233575 A1) discloses a technique of disposing a ceramic heater (hereinafter, referred to as a heater) as a heating body at a nip portion including a fixing member and pressing member, and fixing a non-fixed toner image onto a surface of a recording material by a pressing force of a fixing area while heat of the heater is applied through the fixing belt. The technique has the advantage that since the thermal capacity of a heater and a fixing member is small, standby time taken until it becomes possible to perform forming an image, after the power of the image forming apparatus is turned on (quick start performance), and the power consumed during standby is also very small (power-saving).

Further, the time energizing the fixing device can be reduced as much as possible for saving energy. The control of energizing the heater only during the performance of an image forming operation or the preliminary operation of the image forming operation, not energizing the heater during the standby time, is also used in the belt-fixing system.

On the other hand, a method that performs fixing, using residual heat of a fixing device, by turning off a heater at a predetermined timing based on a position of a recording material before a rear end of the recording material passes through the fixing device, is described in Japanese Patent Laid-Open No. 08-171307. That is, energizing the heater of the fixing device is stopped at a predetermined timing in consideration of a thermal time constant of the fixing device that is used based on the position of the recording material. It is possible to reduce power in the image forming operation by performing the control.

The invention further developed the technology of Japanese Patent Laid-Open No. 08-171307. That is, when the fixing device with small thermal capacity such as the belt-fixing system is used, the reduction amount of temperature of the fixing device when the heater is turned off according to the temperature state of the fixing device is considerably changed. Further, the reduction amount of temperature is large, when the fixing device is cold, whereas the reduction amount of temperature is small, when the fixing device is sufficiently warm. Accordingly, it is found that there is a case in which a poor fixing occurs due to too large reduction of the temperature or a case in which it is difficult to obtain an effect of reducing the power consumption, depending on the timing of stopping the energization of the heater.

Further, it is found that since the fixable temperature or the reduction amount of temperature of the fixing device is changed even by the kind of the passed recording material or the installation environment of the apparatus, the similar events occur.

### SUMMARY OF THE INVENTION

It is desirable to provide an exemplary configuration of an image heating apparatus according to the invention which includes: an image heating portion that heats a recording material bearing an image to be conveyed, using heat from a heater; a temperature sensor that senses a temperature of the image heating portion; a thermal controller that controls a heating operation of the heater based on the temperature sensed by the temperature sensor; a recording material detector that detects a position of a recording material on a conveying path at an upstream side further than the image heating portion in a recording material-conveying direction; and a controlling device that controls a timing of stopping the heating operation of the image heating device based on a sensing result of the recording material detector.

Further, it is desirable to provide an exemplary configuration of an image heating system according to the invention which includes: a conveying path configured to convey a recording material bearing an image; an image heating portion configured to heat a recording material conveyed on the conveying path, using heat from a heater; a temperature sensor configured to sense a temperature of the image heating portion; a thermal controller configured to control a heating operation of the heater based on the temperature sensed by the temperature sensor; a recording material detector configured to detect a position of a recording material on the conveying path at an upstream side further than the image heating portion in a recording material-conveying direction; and a controlling device configured to control a timing of stopping the heating operation of the image heating device based on a sensing result of the recording material detector.

According to the invention, it is possible to reduce the amount of consumed power without generating a poor image.

Further features of the present invention will become apparent from the following description of exemplary embodiments with reference to the attached drawings.

### BRIEF DESCRIPTION OF THE DRAWINGS

FIG. 1 is a longitudinal cross-sectional view schematically illustrating a configuration of an example of an image forming apparatus.

FIG. 2 is a partial enlarged view of an image forming apparatus.

FIG. 3 is an operational process diagram of an image forming apparatus.

FIG. 4 is a transversal cross-sectional view schematically illustrating main parts of a fixing device (image heating device) according to a first embodiment.

FIG. 5A and FIG. 5B are views illustrating a configuration of a heater and an energization control circuit.

FIG. 6 is a flowchart illustrating a stopping operation of energizing a heater of the first embodiment.

FIG. 7 is a diagram illustrating transition of a fixing-belt surface temperature of a comparative example.

FIG. 8 is a diagram illustrating transition of a fixing-belt surface temperature of the first embodiment.

### DESCRIPTION OF THE EMBODIMENTS

Although detailed examples of exemplary embodiments (examples) of the invention will be described with reference to the drawings, the invention is not limited to the embodiments described below.

### First Embodiment

### Description of Image Forming Apparatus

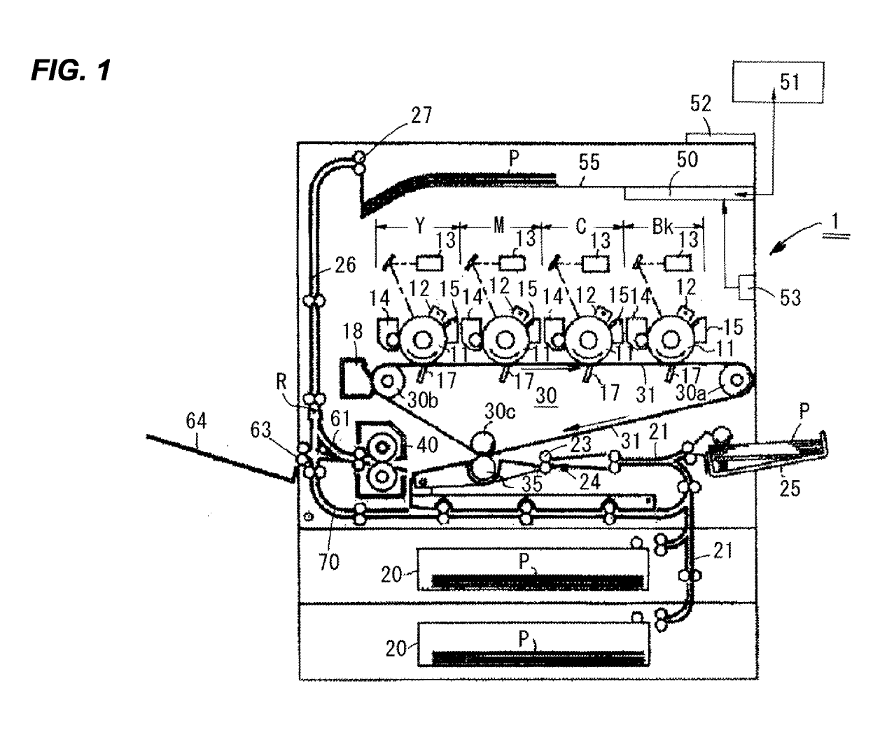

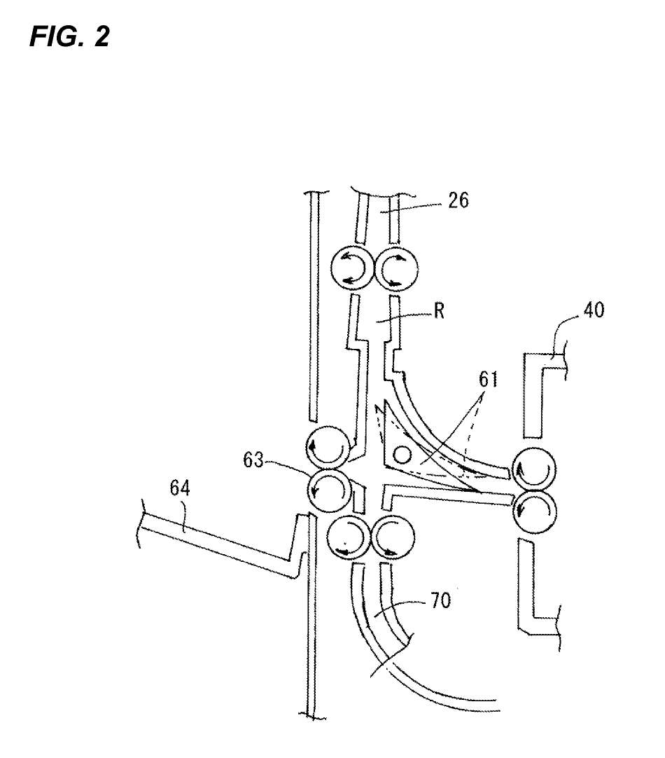

FIG. 1 is a longitudinal cross-sectional view schematically illustrating a configuration of a color electrophotographic printer 1 (hereinafter, referred to as a printer) which is an example of an image forming apparatus equipped with an image heating device or an image heating system according to the invention. FIG. 2 is a partial enlarged view of the image forming apparatus.

The printer 1 can form a full color image on a sheet-shaped recording material P by performing an operation for forming an image (printing operation) in response to input image information from a host device 51 communicatively connected with a control circuit portion (controlling device: CPU) 50, and output the image as a hardcopy. The host device 51 is a computer, an image reader, or a fax machine. The control circuit portion 50 transmits and receives signals to and from the apparatus 51 or an operation portion 52. Further, the control circuit portion 50 controls an imaging sequence by transmitting and receiving signals to and from various imaging devices of the printer 1. The recording material P is an object where a toner image is formed. The recording material P may be plain paper, a sheet-shaped material made of resin, a cardboard, or a sheet for an overhead projector.

Four of first to fourth image forming portions Y, M, C, and Bk are horizontally disposed in parallel in the body of the printer 1, from the left to the right in the figure. The image forming portions are all laser-exposing system of electrophotographic process mechanisms and have the same configuration, except that the colors (toner) of developers contained in a development device are different from each other.

That is, the image forming portions each include a drum type of electrophotographic photoreceptor (image bearing member; hereinafter, referred to as a drum) 11 which rotatably drives in the counterclockwise direction, as indicated by an arrow, at a predetermined speed. Further, a charging unit 12, a laser scanner 13, a development device 14, a primary transfer blade 17, and a cleaner 15, which are process units operating for the drum 11, are disposed around each of the drums 11.

An intermediate transfer belt unit 30 is disposed under the image forming portions Y, M, C, and Bk. The unit 30 includes a flexible endless intermediate transfer belt 31 (hereinafter, referred to as a belt), and a driving roller 30a, a tension roller 30b, and a secondary transfer counter roller 30c, around which the belt 31 is stretched. The primary transfer rollers 17 of the image forming portions Y, M, C, and Bk are disposed inside the belt 31 and pressed against the lower sides of the corresponding drums 11 through the upper belt portion of the belt 31 between the roller 30b and the roller 30a. The contact portion between each of the drums 11 and the belt 31 is a primary transfer portion.

A secondary transfer roller 35 is pressed against the roller 30c through the belt 31. The contact portion between the belt 31 and the roller 35 is a secondary transfer portion. The belt 31 is circulatively moves at a speed corresponding to the rotation speed of the drums 11 in the clockwise direction indicated by the arrow by the roller 30a.

In the embodiment, a yellow (Y) developer (chromatic color toner) is contained in the development device 14 of the first image forming portion Y, resulting in forming a Y-color toner image on the drum 11. A magenta (M) developer is contained in the developer 14 of the second image forming portion M, resulting in forming an M-color toner image on the drum 11. A cyan (C) developer is contained in the development device 14 of the third image forming portion C, resulting in forming a C-color toner image on the drum 11. A black (Bk) developer is contained in the development device 14 of the fourth image forming portion Bk, resulting in forming Bk-color toner image on the drum 11.

The control circuit portion 50 controls the image forming portions Y, M, C, and Bk to form images, based on color separation image signals input from the apparatus 51. Accordingly, color toner images of Y-color, M-color, C-color, and Bk-color are formed at predetermined control timings on the surfaces of the drums 11, which rotate, in the image forming portions, respectively. The electrophotographic imaging principle and process for forming toner images on the drums 11 are known in the art and the description is not provided.

The toner images formed on the surfaces of the drums 11 of the image forming portions are sequentially transferred onto the outer surface of the belt 31, which rotates at a speed corresponding to the rotation speed of the drums 11 in a forward direction that is the rotational direction of the drums 11, to overlap each other, at the primary transfer portions. Therefore, a non-fixed full color image (non-fixed image) is formed by overlapping four toner images of the Y-color, the M-color, the C-color, and Bk-color on the surface of the belt 31.

Meanwhile, the control circuit portion 50 separates and feeds a sheet of recording material P from a sheet feeding cassette 20 or a multi-sheet tray 25 at a predetermined sheet-feeding timing. The recording material is conveyed, on a conveying path 21, toward the secondary transfer portion. A registration sensor 24 and a pair of registration rollers 23 are disposed at the upstream side further than the secondary transfer portion in the recording material-conveying direction, on the conveying path 21.

The registration sensor 24 is a sensor that senses whether there is a recording material positioned at the upstream side further than the pair of registration rollers 23 in the recording material-conveying direction and a signal from the registration sensor 24 is input to the control circuit portion 50. The control circuit portion 50 can sense the passing timings of the front and rear ends of a recording material, by the registration sensor 24 detecting whether there is a recording material. That is, the registration sensor 24 is a recording material detector that detects the position of the recording material P on the conveying path, at the upstream side further than the fixing device 40 (image fixing portion), which is an image heating apparatus to be described below, in the recording material-conveying direction.

The pair of registration rollers 23 temporarily receives the front end of the recording material P, which is conveyed through the registration sensor 24, at a nipping portion of the pair of registration rollers 23, which has stopped rotating at that time, and then makes the recording material P straight, when recording material P is in skew-feeding.

The control circuit portion 50 starts the pair of registration rollers 23 rotating such that the front end of the recording material P reaches the secondary transfer portion when the front end of the toner image reaches the secondary transfer portion, in synchronization with the position of the toner image on the belt 31 that is in operation. A series of secondary transfer of the full-colored combined toner image on the belt 31 is sequentially applied to the recording material, which is introduced in the secondary transfer portion by the pair of registration rollers 23, by the secondary transfer roller 35.

The recording material P coming out from the secondary transfer portion is separated from the surface of the belt 31 and is introduced into the fixing device 40, which is an image heating apparatus. The non-fixed toner image of a plurality of colors on the recording material P is melted, with the colors mixed, such that the non-fixed toner image is fixed as a fixed image on the recording material, by the fixing device 40. The surface of the belt 31 after the recording material is separated at the secondary transfer portion is cleaned by removing the remaining sticking-substances such as the remaining secondary transfer toner by a belt cleaner 18, and is then supplied for imaging again. The imaging portion to the fixing device 40 is the image forming portion that forms a non-fixed image onto the conveyed recording material.

Imaging of the image forming portions of the corresponding colors is controlled for a print mode of a single color such as monochrome, a secondary color, or multi-colors, other than the full color. Further, for a single-side print mode, the recording material P coming out from the fixing device 40 is changed in path by a flapper 61 according to a predetermined instruction and discharged to a face-down discharge tray 55 disposed on the top of the printer. Alternatively, the recording material P is discharged to a face-up discharge tray 64 disposed on a side of the printer.

When being discharged to the tray 55, the recording material P coming out from the fixing device 40 is guided upward along the top of the flapper 61 converted in the first posture indicated by a solid line in FIG. 2, and then conveyed upward by the conveying path 26. Further, the recording material P is discharged, with the image side down, onto the tray 55 by first discharge rollers 27. When being discharged to the tray 64, the recording material P that has come out from the fixing device 40 is move straight along the bottom of the flapper 61 converted in the second posture indicated by a dashed double-dotted line in FIG. 2, and then discharged, with the image side up, onto the tray 64 by second discharge rollers 63.

For a double-sided print mode, the recording material P with the first side, which has come out from the fixing device 40 and undergone image-forming/fixing, is guided upward along the top of the flapper 61 converted in the first posture and then conveyed upward by the conveying path 26. The conveying path 26 is converted to reverse, when the rear end of the recording material P reaches a reverse point R while the recording material P is conveyed. Accordingly, the recording material P is switch-back conveyed and enters a double-side conveying path 70. Further, the recording material P enters the conveying path 21 again from the conveying path 70, and is turned over and conveyed to the second transfer portion. Accordingly, an image is transferred onto the second side of the recording material P.

The recording material P that has come out from the secondary transfer portion is introduced into the fixing device 40. The recording material P that has come out from the fixing device 40, with both side printed, is changed in path by the flapper 61 according to a predetermined instruction and then discharged to the tray 55 or the tray 64, as in the one-side print mode. The part including the flapper 61 and the switch-back conveying path 26 is an example of a reversing unit.

<Operational Process of Printer>

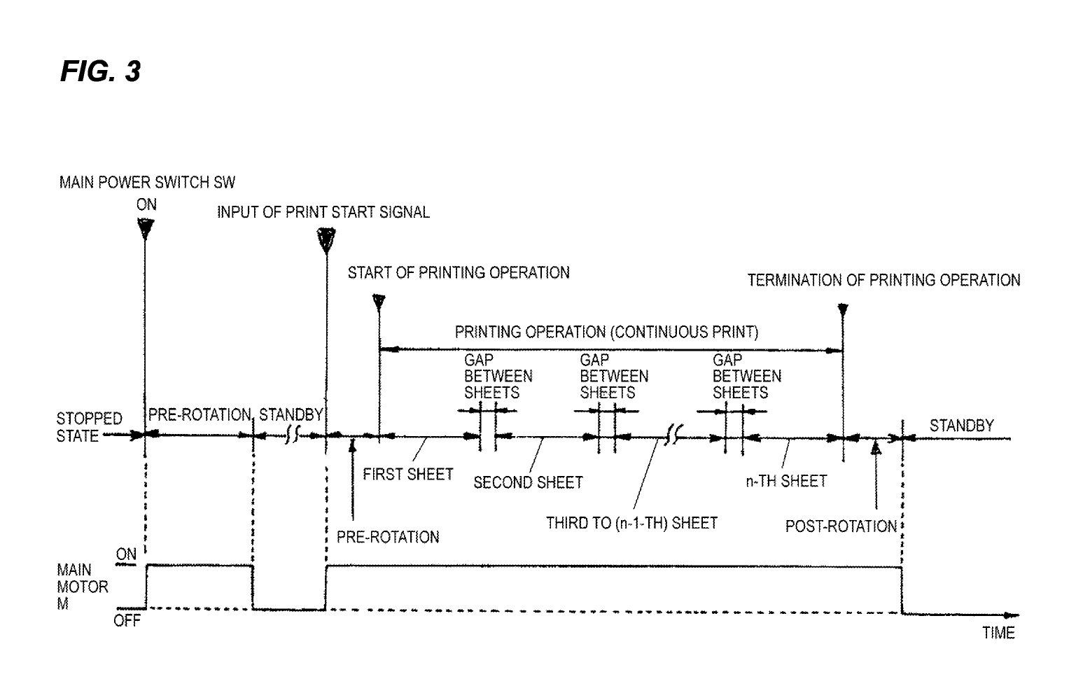

FIG. 3 is a diagram illustrating the operational process of the printer 1 which is performed by the control circuit portion 50.

a) Pre-Multi-Rotation

Pre-multi-rotation is a process of starting the printer that is performed when a main power switch SW of the printer 1 is turned on. The drums 11 of the image forming portions are rotated by starting a main motor M, such that a predetermined process device performs a predetermined warming-up operation.

b) Standby Time (Waiting)

In the standby time, as a predetermined pre-multi-rotation is finished, the main motor M is stopped and it stands by an input of a print start signal (image signal: request for forming an image) from the host device 51 to the control circuit portion 50.

c) Pre-Rotation

The pre-rotation is a pre-printing operation (preliminary action of an image forming operation) that is performed, when a print start signal is input to the control circuit portion 50 from the host device 51. The drums 11 are rotated by starting the main motor M, such that a predetermined process device performs a preparing operation before the image forming operation. The pre-rotation follows the pre-multi-rotation without b) the standby time, when a print start signal is input during a) the pre-multi-rotation.

d) Printing Operation

This is an image forming operation that forms an image, onto the recording material P in response to image information input from the host device 51 to the control circuit portion 50. The printing operation follows the end of predetermined pre-rotation. In the image forming operation, for mono-printing, only one sheet of recording material P is conveyed and the recording material P is printed. For multi-printing (continuous printing mode), a predetermined plurality of sheets of recording materials is continuously conveyed at predetermined intervals (sheet gaps) and the recording materials are sequentially printed (continuously printed).

e) Sheet Gap

In a continuous print job mode, the sheet gap is the interval between the rear end of one recording material and the front end of the next recording material, in which there is no recording material passing the transfer portion (second transfer portion in the embodiment).

f) Post-Rotation

This is a post-operational process that is performed, after a series of printing of a predetermined sheet or plurality of sheets of recording materials (image-forming job) is finished. A predetermined process device performs a predetermined post-operation by keeping the main motor M operating for a predetermined time even after the printing.

g) Standby Time

As a predetermined post-operational process is finished, the main motor M is stopped and it stands by an input of the next print job start signal from the host device 51 to the control circuit portion 50. When the next print job start signal is input, the cycle of the operational processes of c) to f) is performed again.

<Fixing Device> (1) Schematic Configuration of Fixing Device

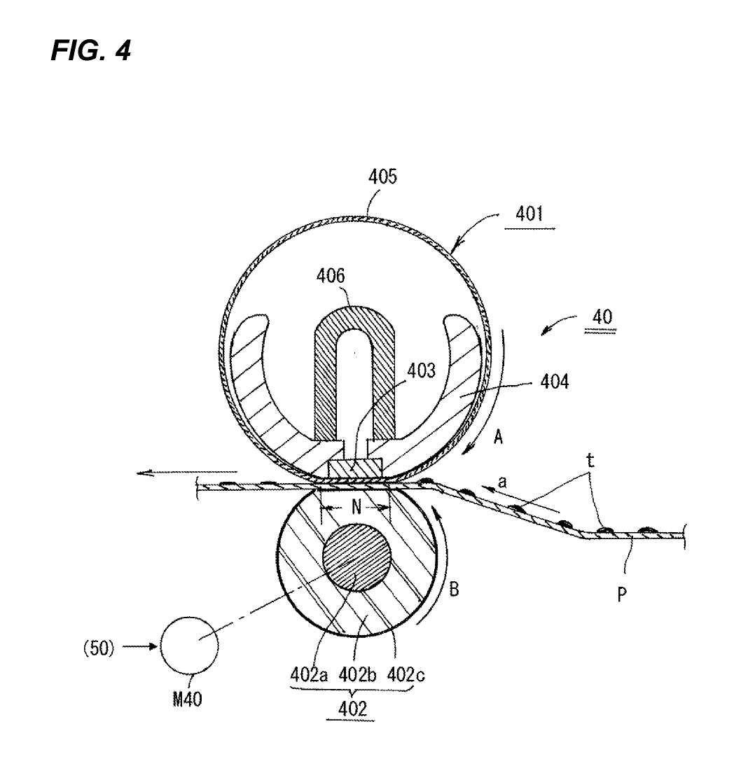

FIG. 4 is a transversal cross-sectional view schematically illustrating main parts of the fixing device (image hating apparatus) 40 according to the embodiment. The fixing device 40 according to the embodiment is a pressure member-driven/tensionless type of belt-fixing-typed fixing device disclosed in Japanese Patent Laid-Open No. 4-44075 to 4-44083, and 4-204980 to 4-204984.

A belt unit 401 is an image heating member (image heating portion), an elastic-pressure roller 402 is a pressure member, and a fixing-nipping portion N is formed between the belt unit 401 and the elastic-pressure roller 402 by disposing vertically in parallel and by coming into press contact therebetween.

In the belt unit 401, a heater guide 404 is a heating body support member and a belt inside guide member, which has a substantially semicircular transversal cross-section and is made from high heat resistant resin having thermally insulation, and high heat resistance and rigidity. The heater guide 404 is a horizontally long member having the longitudinal direction perpendicular to the surface of the figure and a heating body 403 (hereafter, referred to as a heater), which is a heating device, is fitted in a groove longitudinally formed on the underside, and is thermally insulated and held to be fixed. A metal stay 406 reinforces the heater guide 404.

A cylindrical belt 405 (hereafter, referred to as a fixing belt) is a flexible member having high heat resistance and is loosely and externally fitted around an assembly of the heater guide 404, the heater 403, and the stay 406. That is, the inner circumferential length of the fixing belt 405 and the outer circumferential length of the heater guide 404 including the heater 403 and the stay 406 are larger at the fixing belt 405, and accordingly, the fixing belt 405 is externally fitted such that the circumferential length of the fixing belt 405 has a space with respect to the heater guide 404.

The fixing belt 405 is, for example, a thin film cylinder with a base layer made of polyamide having a thickness of about 30 μm to 100 μm, to which PFA or PTFE coating is applied, with a primer layer therebetween on the base layer, such that toner parting properties from a toner image is maintained. The fixing belt 405 may be a flexible metallic cylindrical body or a multilayered cylindrical body having a metal layer.

The elastic roller 402, a pressure member, is pressed in contact with the underside of the heater 403 of the belt unit 401 under predetermined pressure by a pressing unit (not illustrated), against the elasticity of the pressure roller 402, with the fixing belt 405 therebetween. Therefore, the fixing-nipping portion N having a predetermined width for thermal fixing is formed in the recording material-conveying direction a. The stay 406 of the belt unit 401 prevents deformation of the heater guide 404 or the heater 403 when being pressed by the pressure roller 402.

The pressure roller 402 includes a metal shaft 402a, an elastic layer 402b made of silicon rubber, and a toner parting layer 402c made of PFA to have a thickness of about 10 μm to 100 μm with a primer layer therebetween on the elastic layer 402.

As the driving force of a fixing motor M40 controlled by the control circuit portion 50 is transmitted through a driving force transmission mechanism (not illustrated), the pressure roller 402 rotates counterclockwise (in the direction of the arrow B), which is the conveying direction of the recording material P, at a predetermined circumferential velocity (pressing-member driving type). With the rotation of the pressure roller 402, a rotational force is applied to the cylindrical belt 405 by a friction force at the fixing-nipping portion N between the pressure roller 402 and the outer side of the fixing belt 405. Therefore, the inner side of the fixing belt 405 slides in close contact with the underside of the heater 403 at the fixing-nipping portion N, such that the outside of the heater guide 404 is driven to rotate clockwise (in the direction of the arrow A).

Heat resistant grease is applied to the friction surfaces of the heater 403 and the fixing belt 405 in consideration of improvement of abrasion resistance of the fixing belt 405, stable rotation of the fixing belt 405, and uniform heat transfer to the fixing belt 405. The heat resistant grease used in the embodiment is HP-300 made of perfluorinated polyether that is base oil or polytetrafluoroethylene (PTFE) that is a thickener, by Dow Corning Asia Co., Ltd.

The fixing roller 405 is rotated by the rotation of the pressure roller 402, and as described below, the heater 403 increases in temperature to be adjusted to a desired temperature by supplying power to the heater 403. In this state, the recording material P with a born non-fixed toner image t is introduced into between the fixing belt 405 and the pressure roller 402 at the fixing-nipping portion N and passes through the fixing-nipping portion N, together with the fixing belt 405, with the toner image-born side of the recording material P in close contact with the outer side of the fixing belt 405.

Therefore, the heat of the heater 403 is applied to the recording material P through the fixing belt 405 and the non-fixed toner image t is thermally fixed onto a side of the recording material P. The recording material P that has passed through the fixing-nipping portion N is curvature-separated from the fixing belt 405 and conveyed to be discharged.

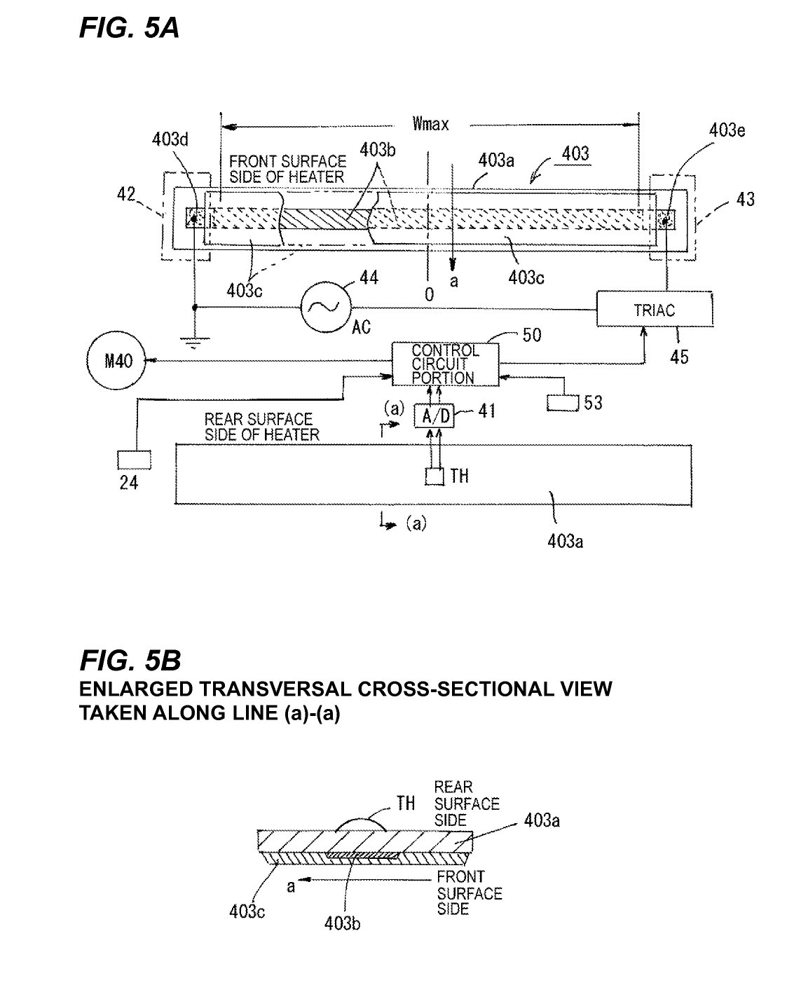

FIG. 5A and FIG. 5B are views illustrating the configuration of the heater 403 and an energization control circuit according to the embodiment. The heater 403 includes a thin and long substrate 403a that has the longitudinal direction perpendicular to the conveying direction (a) of the recording material P, which is a member to be heated, and has heat resistance, an insulation property, and good heat conductivity. A resistance heating element 403b formed in the longitudinal direction of the substrate is disposed on the side (on which the fixing belt slides) of the substrate 403a. A heat resistant overcoated layer 403c that protects the side of the heater where the resistance heating element 403b is formed is provided. Further, power supply electrodes 403d and 403e are provided at both longitudinal ends of the resistance heating element 403b. The heater 403 has low heat capacity in the entire configuration.

For example, a ceramic material such as alumina or aluminum nitride is used for the substrate 403a. The resistance heating element 403b is formed in a narrow stripe shape on the substrate 403a by screen-printing a paste made by kneading silver, palladium, glass powder (inorganic binding agent), and an organic binding agent. An electric-resistive material such as RuO₂ and Ta₂N, other than silver-palladium (Ag/Pd), may be used for the material of the resistance heating element.

The power supply electrodes 403d and 403e were formed by screen-printing silver-palladium. The main object of the overcoated layer 403c is to ensure electrical insulation between the resistance heating element 403b and the fixing belt 405 and the performance of sliding on the fixing belt 405. The overcoated layer 403c is, for example, a heat resistant glass layer having a thickness of about 50 μm.

The heater 403 is held and fixed on the underside of the stay 404 with the side, where the overcoated layer 403c is formed, exposed downward. A temperature sensor TH is provided to sense the temperature of the heater 403, and is disposed on the rear side of the heater, that is, the opposite side to one side of the substrate 403a where the resistance heating element 403b is disposed. In the embodiment, a thermistor is used as the temperature sensor TH.

The maximum sheet-passing width Wmax for the recording material S is provided in the fixing device 40. In the embodiment, sheet passing of recording materials with large and small sizes of widths through the fixing device 40 is implemented by center-based conveyance based on the center of a recording material width. The size of width of the recording material is the dimension in the direction perpendicular to the conveying direction (a) of the recording material within the surface of the conveying path of a recording material. A center-based conveyance line 0 (imaginary line) is provided for the recording material S. The resistance heating element 403b is a little longer than the maximum sheet-passing width Wmax.

The thermistor TH is disposed at the longitudinal center of the heater 403 (the portion of the heater which substantially corresponds to the position of the center-based conveyance line 0 in the embodiment) to sense the temperature of the portion of the heater which is the sheet-passing area even for recording materials with any of large and small sizes of widths. The heater temperature (electrical information about the temperature) sensed by the thermistor TH is input to the control circuit portion 50 through an A/D converter 41.

Power supply connectors 42 and 43 are attached over the power supply electrodes 403d and 403e of the heater 403 fixed and supported by the stay 404, with the electric contact points of the connectors 42 and 43 in contact with the power supply electrodes 403d and 403e, respectively. In the heater 403, as power is supplied between the power supply electrodes 403d and 403e through a triac 45 from a commercial power supply (AC power supply) 44, the resistance heating element 403b is heated throughout the length and rapidly and steeply increased in temperature.

The increased temperature is sensed by the thermistor TH and the output from the thermistor TH is A/D converted and transmitted to the control portion 41. The control portion 41 controls the heater 403 at a predetermined temperature by controlling the power supplied to the resistance heating element 403b by the triac 45, using phase control or frequency control, based on the information.

Heat resistant grease is applied to the friction surfaces of the heater 403 and the fixing belt 405 in consideration of improvement of abrasion resistance of the fixing belt 405, stable rotation of the fixing belt 405, and uniform heat transfer to the fixing belt 405. The heat resistant grease used in the embodiment is HP-300 made of perfluorinated polyether that is base oil or polytetrafluoroethylene (PTFE) that is a thickener, by Dow Corning Asia Co., Ltd.

(2) Energization control for heater In the fixing device 40 of the embodiment, the belt unit 401 is an image heating portion that heats the recording material P that is conveyed, with an image t born, using the heat from the heater 403 that is a heating device. The thermistor TH is a temperature sensor that senses the temperature of the belt unit 401 that is an image heating portion. A temperature-controlling portion of the control circuit portion 50 is a thermal controller that controls the heating of the heater 403, which is a heating device, based on the temperature sensed by the thermistor TH that is a temperature sensor. The registration sensor 24 is a recording material sensing unit that senses the position of a recording material on the conveying path, at the upstream side further than the belt unit 401, which is an image heating portion, in the recording material-conveying direction.

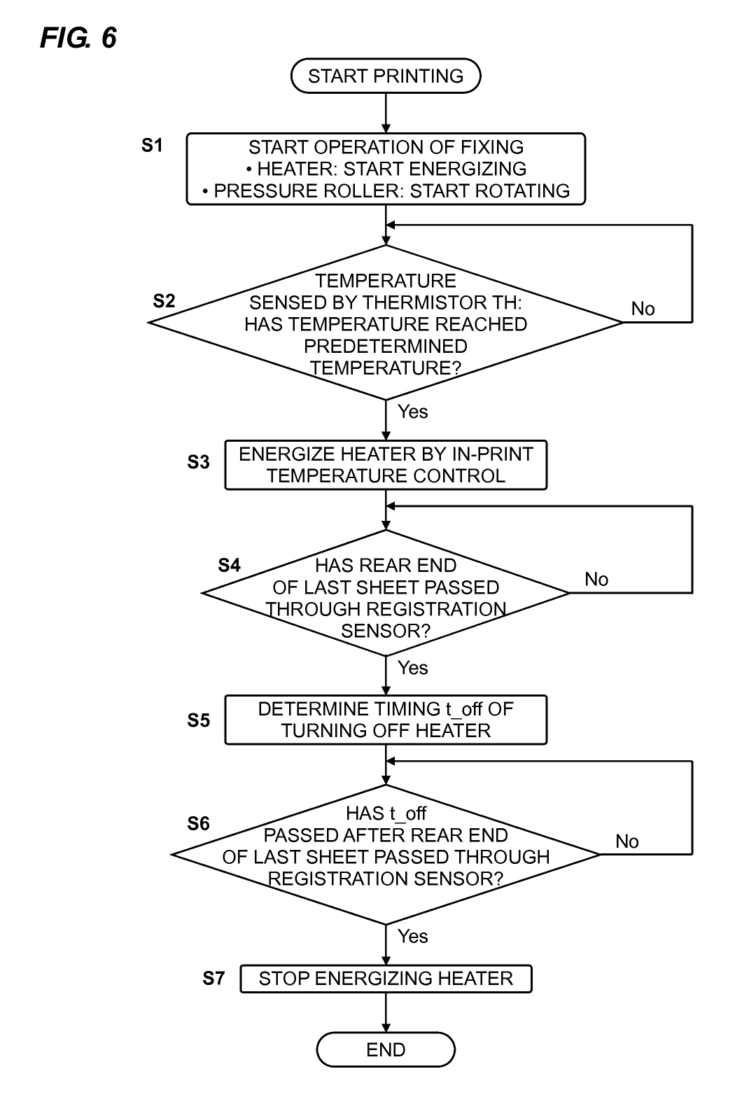

An energization control operation on the heater 403 that is a heating device is described based on the flowchart illustrated in FIG. 6. The timing of starting the energization control operation on the heater 403 by the temperature-controlling portion of the control circuit portion 50 may be, for example, earlier than starting printing such as a standby state that stands by input of a printing start signal after pre-multi-rotation is finished. However, the printing may be performed from the point of time where printing is started or the point of time where pre-printing is sensed, such as that an original set is detected or an input through the operation portion 52 is sensed by a user, in order to reduce the power consumption. In the embodiment, when the energization control on the heater 403 at the point of time where printing is started is described.

When the printer 1 starts printing, the temperature-controlling portion of the control circuit portion 50 starts energization on the heater 403. Further, in steps S1 and S2, as the pressure roller 402 starts to rotate, the all circumferences of the fixing belt 405 and the pressure roller 402 are heated and the process of fixing is performed until the temperature sensed by the thermistor TH becomes a predetermined temperature.

In step S3, the temperature-controlling portion of the control circuit portion 50 controls the heater 403 by performing in-print temperature control, after the temperature sensed by the thermistor TH reaches the predetermined temperature. In the in-print temperature control, energization on the heater 403 is controlled based on the temperature sensed by the thermistor TH such that the heater 403 reaches a predetermined fixing temperature T_print. The in-print temperature control is continuously performed during continuous printing, in which the temperature sensed by the thermistor TH is substantially maintained at T_print.

Further, a heating stop-controlling portion (heating stop controlling device) of the control circuit portion 50, as described below, determines the timing of stopping the heating of the heater 403, which is a heating device, to be earlier than the timing where the rear end of the recording material P passes through the belt unit 401 that is an image heating portion. Further, the temperature-controlling portion of the control circuit portion 50 stops the heating of the heater 304 at the timing determined by the heating stop-controlling portion of the control circuit portion 50 based on the position of the recording material sensed by the registration sensor 24 that is a recording material detector.

In detail, in the embodiment, the heating stop-controlling portion of the control circuit portion 50 stops energizing the fixing heater 403 at a heater operation-stopping timing earlier by Δt second where the last sheet (n-th sheet of recording material) in continuous printing passes through the fixing-nipping portion N. Steps S4 to S7 are the control steps. In the embodiment, the timing when a heater-off time t_off has elapsed after it is sensed that the rear end of the last sheet passes the registration sensor 24 is set to coincide with the heater operation-stopping timing.

The heating stop-controlling portion of the control circuit portion 50 starts to measure time from the timing when the rear end of the last sheet in continuous printing has passed the registration sensor 24. Further, the heater operation-stopping timing is determined based on all of conditions at the point of time. Accordingly, the heater-off time is determined. The energizing the heater 403 is stopped at the point of time when the t_off second has elapsed after the rear end of the last sheet passes the registration sensor 24. However, the rotation of the pressure roller 402 is stopped, after the last sheet passes through the fixing-nipping portion N.

The time when the rear end of the last sheet completely passes through the fixing-nipping portion N after passing the registration sensor 24 is calculated from the conveying speed (process speed) of the recording material and the length of the recording material-conveying path from the registration sensor 24 to the fixing-nipping portion N.

(3) Determination of Heater Operation-Stopping Timing

A method of determining the heater operation-stopping timing is described. In the embodiment, the heating stop-controlling portion of the control circuit portion 50 determines the heater operation-stopping timing based on the temperature state of the fixing device 40 (belt unit 401). It is assumed that the temperature sensed by the thermistor TH right before starting to energize the heater 403 is a fixing temperature at the start of printing T_start, when printing is started. The T_start indicates the degree of accumulated heat when the fixing device 40 starts printing. That is, the temperature state of the fixing device 40 is determined by the temperature sensed by the thermistor TH when a series of fixing (image forming job) is started (when image heating is started).

Instead of the T_start, the temperature of the fixing belt 405 or the temperature of the pressure roller 402 may be used as the value indicating the degree of accumulated heat when the fixing device 40 starts printing. Further, the time after the previous print job is finished (the heating time of the heater 403 in a series of fixing (image heating)) may be used as the value indicating the degree of accumulated heat when the fixing device 40 starts printing.

The time until the rear end of the last sheet passes the registration sensor 24 after printing is started and the heater 402 is energized for the print job is the t_print. The t_print indicates the degree of heating the fixing device 40 during the printing.

Instead of the t_print, the number of sheets or the size and the kind of the recording material P in the print job, and the amount of accumulated power during the print job may be used as the value indicating the degree of heating the fixing device 40 during the print job.

In the embodiment Δt based on the T_start and t_print is determined by using Table 1, which is a heater operation-stopping timing table.

TABLE 1
Heater Operation-Stopping Timing Table

| | t_print < | 150 s ≦ t_print < | 300 s ≦ |
|---|---|---|---|
| | 150 s | 300 s | t_print |
| T_start < | Δt(cold) | Δt(mid) | Δt(hot) |
| 80° C. | | | |
| T_start ≧ | Δt(mid) | Δt(hot) | Δt(hot) |
| 80° C. | | | |

Δt has a relation of Δt(hot) > Δt(mid) > Δt(cold).

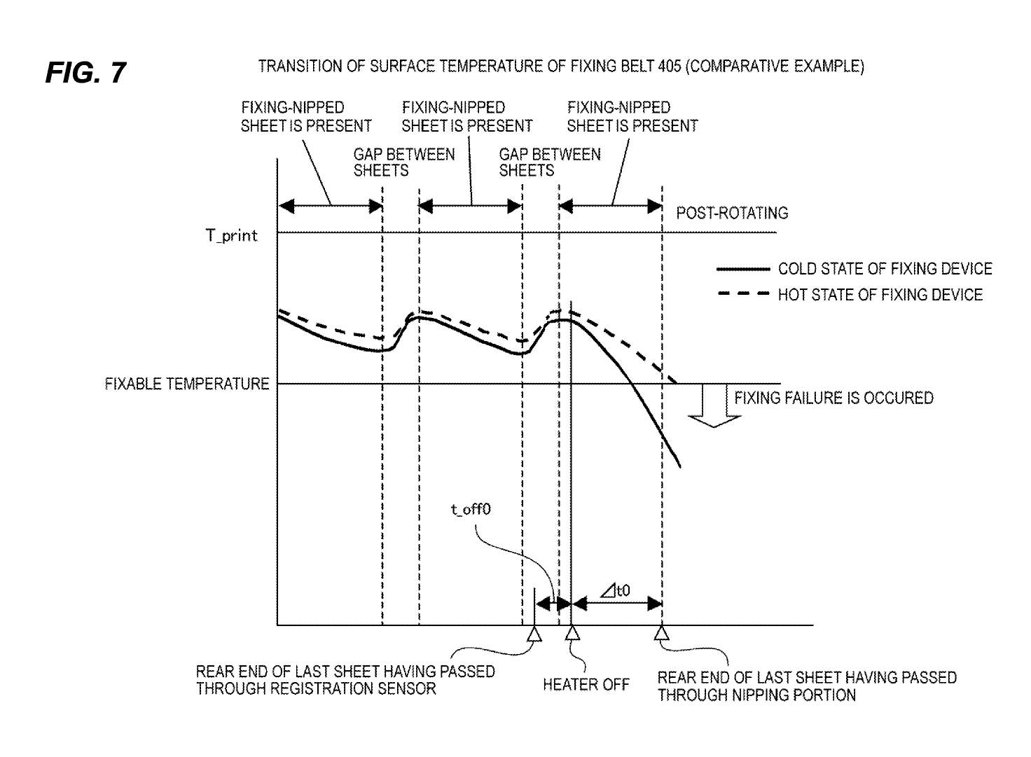

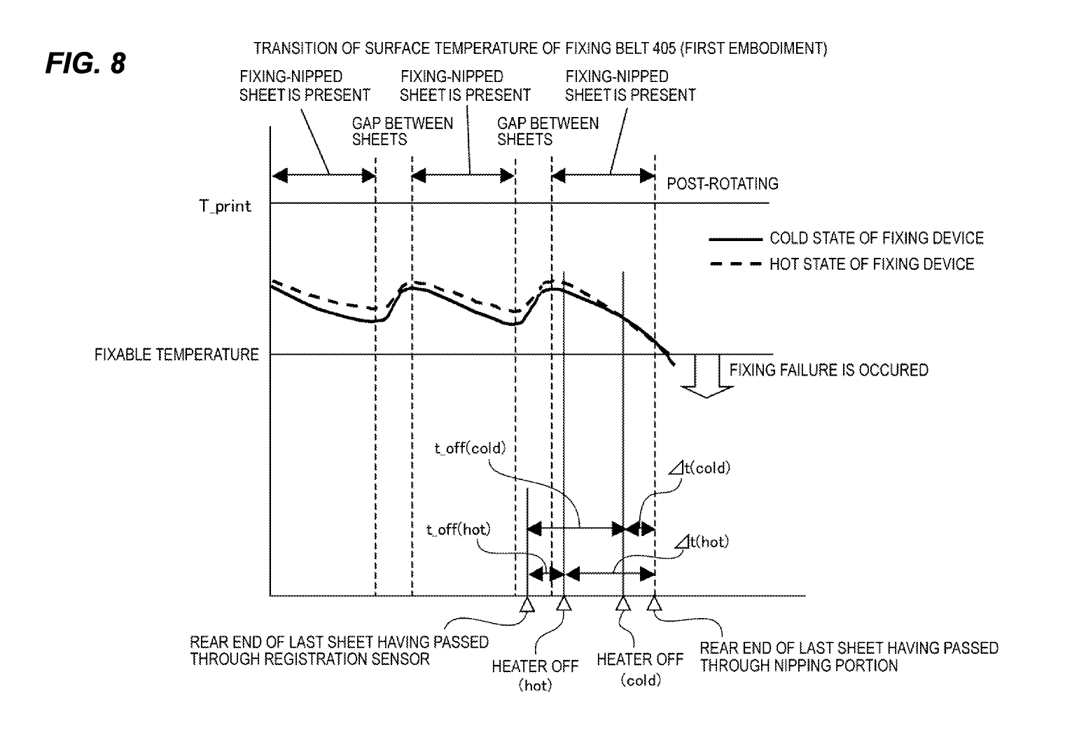

It is assumed that the fixing device 40 has been cold for T_start<80° C. and t_print<150s, which is a cold state of the fixing device. It is assumed that the fixing device 40 has been sufficiently warmed for T_start≧80° C. and t_print≧150s, which is a hot state of the fixing device. Transition of the surface temperature of the belt unit 405 before/after the heater 403 is turned off, in the cold state of the fixing device and the hot state of the fixing device is illustrated in FIGS. 7 and 8.

In the transition of temperature before the heater is turned off in FIGS. 7 and 8, the temperature of the heater is maintained substantially at T_print while the in-print temperature control is performed, as described above. The surface temperature of the fixing belt in this state repeats temperature transition such that the temperature decreases during sheet-passing because heat is taken by the recording material P from the fixing belt while the temperature increases again between the sheets. As the surface temperature of the fixing belt 405 decreases, poor fixing is caused by insufficient heating of the toner under the fixing-possible temperature, such that T_print is set to be the fixing-possible temperature or higher.

FIG. 7 illustrates, as a comparative example, transition of the surface temperature of the fixing belt 405 when the heater is turned off at the same timing in the cold state of the fixing device and the hot state of the fixing device. When the heater is turned off after the heater-off time t_off0 elapses such that the heater operation-stopping timing becomes Δt0, the decrease in temperature after the heater is turned off is attenuated in the hot state of the fixing device, such that poor fixing does not occur. However, the decrease in temperature of the fixing device 40 after the heater is turned off increases in the cold state of the fixing device, such that poor fixing occurs at the rear end of the last sheet.

FIG. 8 illustrates transition of the surface temperature of the fixing belt 405 when the heater is turned off at timing different from that listed in Table 1 in the cold state of the fixing device and the hot state of the fixing device.

Poor fixing does not occur even at the rear end of the last sheet by setting the heater-off time to t_off(cold) larger than t_off0 such that the heater operation-stopping timing becomes Δt(cold) smaller than Δt0, in the cold state of the fixing device.

On the other hand, poor fixing does not occur even if the heater is turned off at timing earlier than the cold state of the fixing device, by setting the heater-off time t_off(hot) is to be the heater operation-stopping timing Δt(hot) in the hot state of the fixing device.

As described above, for the temperature state of the fixing device 40, as the heater operation-stopping timing Δt and the heater-off time t_off are determined from the temperature transition after the heater is turned off, it is possible to reduce the power consumption without poor fixing.

Although the heater operation-stopping timing Δt and the heater-off time t_off are determined by the temperature state of the fixing device 40 in the embodiment, the heater operation-stopping timing Δt and the heater-off time t_off may be determined by the environment temperature/humidity. That is, in FIGS. 1 and 5, an environment sensor (environment detector) 53 is disposed in the image forming apparatus (or the image heating device) and senses the temperature and humidity of the environment. The information on the temperature and humidity sensed by the environment sensor 53 is input to the control circuit portion 50. Predetermined conditions determined by the heating stop-controlling portion of the control circuit portion 50 are specified based on the temperature and humidity sensed by the environment sensor 53.

In this case, since the decrease in temperature of the fixing device 40 is large under a low-temperature or high-humidity environment, the heater operation-stopping timing Δt and the heater-off time t_off may be set to be small and large, respectively. Further, the heater operation-stopping timing Δt and the heater-off time t_off may be set to be large and small, respectively, under a high-temperature or low-humidity environment.

Further, the heater operation-stopping timing Δt and the heater-off time t_off may be determined by the kind of the recording material P that is conveyed (passed). In this case, since the temperature decrease of the fixing device 40 is large, for a recording material with a large weight (basis weight) per unit area, such as a cardboard, the heater operation-stopping timing Δt and the heater-off time t_off may be set to be small and large, respectively. Further, the heater operation-stopping timing Δt and the heater-off time t_off may be set to be large and small, respectively, for a recording material with a small basis weight. Various pieces of information of the conveyed recording material P is input to a user from a selection-designating unit of the operation portion 52 or the host device 51 with respect to the control circuit portion 50.

### Second Embodiment

The embodiment is different from the first embodiment in that the heating operation-stopping portion of the control circuit portion 50 determines the heater operation-stopping timing Δt by sensing the rear end of an image formed on a recording material, instead of sensing the rear end of the recording material P.

As a method of sensing the rear end of an image, there is a method of sensing a changing point from the area with an image to the area without an image, at the rear end of a recording material, from image information that is used when the laser scanner 13 forms a latent image.

As the position of the rear end of an image is detected and the heater operation-stopping timing Δt and the heater-off time t_off are determined for the position of the rear end of the image, it is possible to stop the operation of the heater at a timing earlier than stopping of the operation of the heater, for the rear end of the recording material.

[Other Matters]

1) Although it was described to operate the heating stop controller only for the last recording material (the last sheet) in a continuous print job in the embodiments, similarly, it is possible to operate the heating stop controller for one sheet of recording material even in mono-printing.

2) The following control may be applied, when recording materials are continuously conveyed and the gap between the recording materials (sheet gap) is a predetermined time or more, in an image forming apparatus and an image heating device that can change the process speed according to the thickness of a passing recoding material. That is, the heating stop controller is operated for a previous recording material.

3) The image heating device is not limited to the belt-heating type of the embodiments. Various heating types of image heating devices having the configurations known in the art such as a thermal roller type, a thermal chamber type, an infrared light irradiation type, and electronic heating type may be used.

4) Alternatively, the image heating apparatus is not limited to the fixing device. A gloss increasing apparatus (image quality improving apparatus) that increases the gloss of an image by heating an image fixed on a recording material may be used.

5) The image forming portion of the image forming apparatus is not limited to the electrophotographic system. The image forming portion may be an electrostatic recording system or a magnetic recording system. Further, the image forming portion is not limited to a transfer system and may be configured to directly form a non-fixed image on a recording material.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2011-250497, filed Nov. 16, 2011, which is hereby incorporated by reference herein in its entirety.

What is claimed is:

1. An image heating apparatus comprising:
an image heating portion configured to heat a recording material bearing an image to be conveyed, using heat from a heater;
a temperature sensor configured to sense a temperature of the image heating device;
a thermal controller configured to control a heating operation of the heater based on the temperature sensed by the temperature sensor;
a recording material detector configured to detect a position of a recording material on a conveying path at an upstream side further than the image heating portion in a recording material-conveying direction; and
a controlling device configured to control a timing of stopping the heating operation of the image heating device based on a sensing result of the recording material detector.

2. The image heating apparatus according to claim 1, wherein predetermined conditions that are determined by the controlling device are based on a temperature state of the image heating portion.

3. The image heating apparatus according to claim 1, wherein a temperature state of the image heating portion is determined according to a heating operation time of the heater in a series of image heating operations.

4. The image heating apparatus according to claim 2, wherein the temperature state of the image heating portion is determined according to the temperature sensed by the temperature sensor when a series of image heating operations is started.

5. The image heating apparatus according to claim 1, wherein predetermined conditions that are determined by the controlling device are based on a temperature or humidity sensed by an environment detector that detects the temperature or the humidity of the environment where the image heating device is disposed.

6. The image heating apparatus according to claim 1, wherein predetermined conditions that are determined by the controlling device are based on the kind of the conveyed recording material.

7. The image heating apparatus according to claim 1, wherein predetermined conditions that are determined by the controlling device are based on the information about an image formed on the recording material.

8. The image heating apparatus according to claim 1, wherein a heating stop-controlling unit operates only for the last recording material, when recording materials are continuously conveyed.

9. The image heating apparatus according to claim 1, wherein the controlling device operates for a previous recording material, in a case where a gap between recording materials is a predetermined time or more when the recording materials are continuously conveyed.

10. An image forming apparatus which includes
an image forming unit configured to form a non-fixed image on a conveyed recording material, and
an image fixing unit configured to fix the non-fixed image by heating the recording material conveyed from the image forming unit, the image forming apparatus comprising:
an image heating portion configured to heat a recording material bearing an image to be conveyed, using heat from a heater;
a temperature sensor configured to detect a temperature of the image heating device;
a thermal controller configured to control a heating operation of the heater based on the temperature sensed by the temperature sensor;
a recording material detector configured to detect a position of a recording material at an upstream side further than the image heating portion in a recording material-conveying direction; and
a controlling device configured to control a timing of stopping the heating operation of the image heating device based on a sensing result of the recording material detector.

11. The image forming apparatus according to claim 10, wherein predetermined conditions that are determined by the controlling device are based on a temperature state of the image heating portion.

12. The image forming apparatus according to claim 10, wherein a temperature state of the image heating portion is determined according to a heating operation time of the heater in a series of image heating operations.

13. The image forming apparatus according to claim 11, wherein the temperature state of the image heating portion is determined according to the temperature sensed by the temperature sensor when a series of image heating operations is started.

14. The image forming apparatus according to claim 10, wherein predetermined conditions that are determined by the controlling device are based on a temperature or humidity sensed by an environment detector that detects the temperature or the humidity of the environment where the image heating device is disposed.

15. The image forming apparatus according to claim 10, wherein predetermined conditions that are determined by the controlling device are based on the kind of the conveyed recording material.

16. The image forming apparatus according to claim 10, wherein predetermined conditions that are determined by the controlling device are based on the information about an image formed on the recording material.

17. The image forming apparatus according to claim 10, wherein the controlling device operates only for the last recording material, when recording materials are continuously conveyed.

18. The image forming apparatus according to claim 10, wherein the controlling device operates for a previous recording material, in a case where a gap between recording materials is a predetermined time or more when the recording materials are continuously conveyed.

19. An image heating system comprising:
a conveying path configured to convey a recording material bearing an image;
an image heating portion configured to heat a recording material conveyed on the conveying path, using heat from a heater;
a temperature sensor configured to sense a temperature of the image heating device;
a thermal controller which controls a heating operation of the heater based on the temperature sensed by the temperature sensor;
a recording material detector configured to detect a position of a recording material at an upstream side further than the image heating portion in a recording material-conveying direction; and
a controlling device configured to control a timing of stopping the heating operation of the image heating device based on a sensing result of the recording material detector.

20. The image heating system according to claim 19, wherein predetermined conditions that are determined by the controlling device are based on a temperature state of the image heating device.

21. The image heating system according to claim 19, wherein a temperature state of the image heating device is determined according to a heating operation time of the heater in a series of image heating operations.

22. The image heating system according to claim 20, wherein the temperature state of the image heating device is determined according to the temperature sensed by the temperature sensor when a series of image heating operations is started.

23. The image heating system according to claim 19, wherein predetermined conditions that are determined by the controlling device are based on a temperature or humidity sensed by an environment detector that detects the temperature or the humidity of the environment where the image heating device is disposed.

24. The image heating system according to claim 19, wherein predetermined conditions that are determined by the controlling device are based on the kind of the conveyed recording material.

25. The image heating system according to claim 19, wherein predetermined conditions that are determined by the controlling device are based on the information about an image formed on the recording material.

26. The image heating system according to claim 19, wherein the controlling device operates only for the last recording material, when recording materials are continuously conveyed.

27. The image heating system according to claim 19, wherein the controlling device operates for a previous recording material, in a case where a gap between recording materials is a predetermined time or more when the recording materials are continuously conveyed.
